(19) United States
(12) Patent Application Publication
(10) Pub. No.: US 2009/0064509 A1
(43) Pub. Date: Mar. 12, 2009

(54) Manually operated hole punch

(76) Inventors: Stuart David Farnworth, Westport, CT (US); Jonathan A. Lee, Milford, CT (US); Javier Verdura, Milford, CT (US)

Correspondence Address: ALIX YALE & RISTAS LLP, 750 MAIN STREET, SUITE 1400, HARTFORD, CT, 06103, US

(21) Appl. No.: 11/899,515

(22) Filed: Sep. 6, 2007

(51) Int. Cl. B26F 1/36

(52) U.S. Cl. 30/363

(57) ABSTRACT

A manually operated single hole punch employs a pair of pivoted members having squeezable handles. A pair of opposed jaws have canopies formed from transparent or semi-transparent material to facilitate alignment of the punch with the material to be punched and to observe a reservoir which receives punched remnants.

### TECHNOLOGICAL BACKGROUND

This application relates to manually operated punches adapted for punching a hole in paper or similar materials. More particularly, this application relates to a single hole punch which is operated by squeezing a pair of handles.

### SUMMARY OF THE DISCLOSURE

In one embodiment a manually operated punch is adapted for punching a single hole. The punch employs a first member comprising a first handle and a first lever hammer which has a punch. A second member comprises a second handle. Opposed first and second jaws are disposed in fixed relationship to the second handle. The second jaw has an anvil aperture. The first and second members are pivotally mounted wherein the handles oppose each other and the jaws oppose each other so that the punch aligns with the aperture. The handles are normally biased apart, and the punch is displaceable into the aperture upon forcing the handles toward each other to thereby punch a hole. The second jaw has a canopy which forms a reservoir at the interior which is exteriorly visible for retaining the remnants of the punched hole.

In one embodiment the jaws each have canopies which are formed from transparent or semi-transparent material. The first and second jaws form a mouth which converges inwardly and is spaced from the punch. The mouth is configured as a narrow restriction to prevent a finger from being exposed to the punch. The handles preferably have a soft overmold portion to facilitate manual grasping and squeezing.

### BRIEF DESCRIPTION OF THE DRAWINGS

FIG. 1 is a side perspective view of a hole punch;

FIG. 2 is a side elevational view of the hole punch of FIG. 1 taken from a generally opposite side thereof;

FIG. 3 is a top plan view of the hole punch for the view of FIG. 2;

FIG. 4 is a front elevational view of the hole punch of FIG. 1.

FIG. 5 is an enlarged fragmentary side view, partly exploded, partly in phantom, and partly in an open position, of the hole punch for the view of FIG. 2;

FIG. 6 is an enlarged fragmentary sectional view of the hole punch taken along the lines of 6-6 of FIG. 5; and

FIG. 7 is an enlarged fragmentary frontal sectional view of the hole punch taken along the lines of 7-7 of FIG. 5.

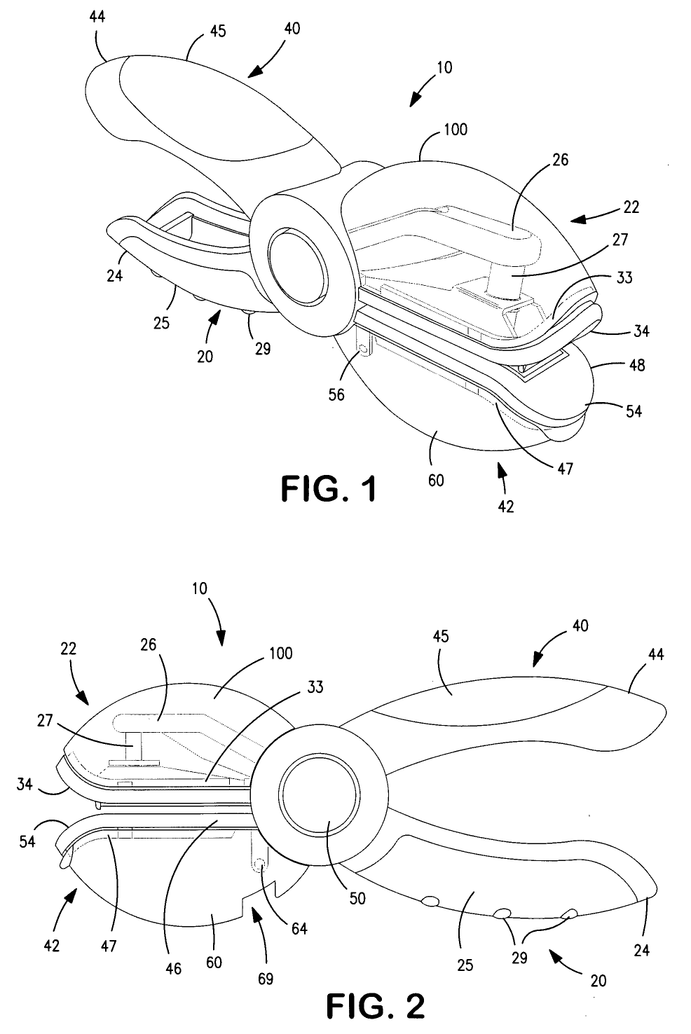

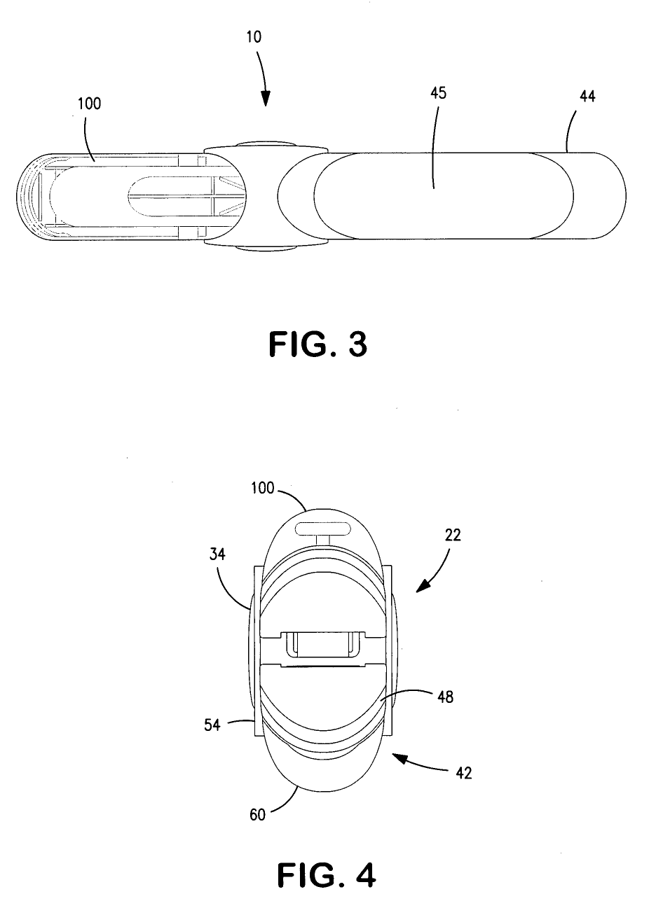

### DETAILED DESCRIPTION

With reference to the drawings wherein like numerals represent like parts throughout the several views, a manually operated hole punch is generally designated by the numeral 10. The hole punch has a contoured, soft touch configuration which facilitates usage thereof and is further adapted to be operated in a safe and effective manner. The hole punch 10 preferably functions to receive a sheet of paper or similar material (neither illustrated) and to, upon manually squeezing a pair of handles, punch a single generally circular hole in the paper or material.

The hole punch 10 is relatively compact and in one embodiment has dimensions of approximately 141 mm in length, a maximum height of 57 mm and a maximum width of 25 mm.

The hole punch comprises a pair of cooperative lever arms 20 and 40 which are connected by a pivot assembly 50. A pair of rotatably fixed jaws 22 and 42 extend forwardly from the pivot assembly 50. The hole punch 10 is configured and operable in a plier-like fashion. Lever arm 20 comprises a handle 24 and a hammer 26. The hammer 26 orthogonally mounts a shaft 27 terminating in a punch 28. The punch 28 reciprocates relative to jaw 22. The punch 28 in one preferred form has an inverted V-shaped configuration.

Lever arm 40 comprises a handle 44 with the handles 24 and 44 being generally similar in shape and disposed in opposing relationship. The handles are dimensioned and contoured for manual grasping.

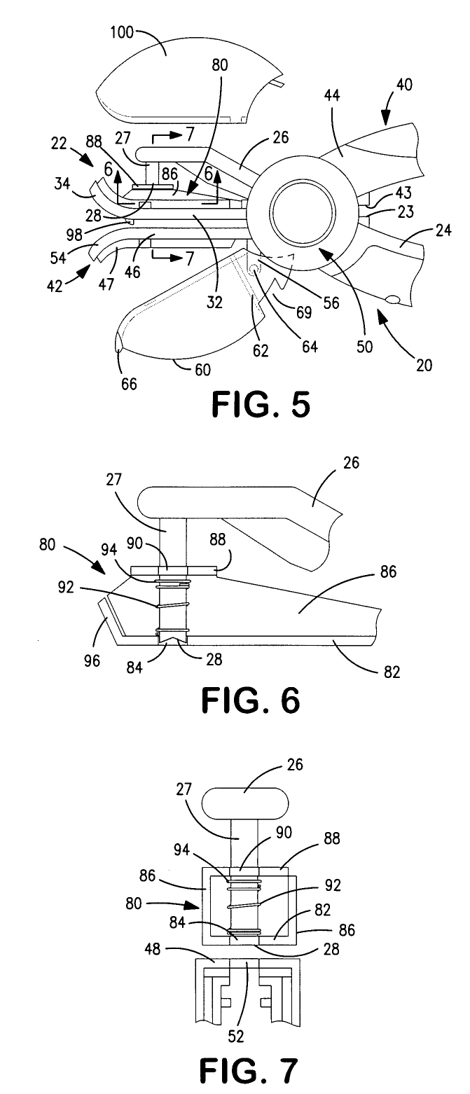

With additional reference to FIGS. 5-7, jaw 42 includes a plate member 46 which receives a metal anvil platform 48 having at an interior location, an anvil aperture 52. The plate 46 tapers outwardly at a forward end 54.

A pair of parallel brackets 56 (FIG. 5) extends orthogonally from the plate. The brackets have a pair of aligned openings which receive inward pivot pins 64 of a canopy 60. The canopy 60 is formed of transparent or semi-transparent material and includes a partition 62 adjacent the pair of inward pins 64 which snap into the openings of the brackets. The canopy includes forward lip 66 so that the canopy may be easily moved from a closed position and pivoted (downwardly in the drawings) to an open position. The canopy 60 also has a rear opening 69. The canopy 60 functions as a reservoir for the punched material. The canopy 60 can accordingly be pivoted to an open position to remove the punched remnants.

Jaw 22 has a plate 32 which is similar in peripheral shape to plate 46 and is disposed in generally opposing relationship to form a mouth. The plate 32 outwardly tapers at forward end 34. It will be appreciated that the tapered portions 54 and 34 of the plates inwardly converge to form a very restricted entry-way to the generally parallel spacing between the plates 32 and 46 of the jaws.

With additional reference to FIGS. 6-7, the plate 32 receives a bent metal frame 80 which has a lower platform 82 with a central opening 84. A pair of side-members 86 support an upper platform 88 which has a opening 90 through which the punch shaft 27 is received. The punch shaft thus reciprocates through the openings 90 and 84. A coil spring 92 is disposed between platform 82 and a retaining ring 94 radially projecting from the punch shaft 27 to bias the punch 28 and the hammer 26 away from the anvil aperture 52. The frame 80 includes an oblique tab 96 (FIG. 6) which engages an underside at the interior front of the tapered portion to help retain the frame 80 to the jaw 22. The frame may also be secured by a rear stud (not illustrated). A pair of projections 98 (FIG. 5) at the forward portion of the plate 32 prevent the plates 32 and 46 from flexibly collapsing into each other under an intense punching force even though the opposed plates are essentially fixed in parallel relationship. A canopy 100 of transparent or semi-transparent material encloses the hammer/punch/frame assembly and has a shape to very similar that of canopy 60.

The jaws 22 and 42 are contoured bulbous members which cooperate to form a bull-nose-type shape. The canopies 60 and 100 are preferably molded from transparent or semi-transparent plastic materials. The plates 32 and 46 respectively have lips 33 and 47 which closely receive the canopies in a snap-fit fashion. Canopy 60 interiorly forms a reservoir for the hole remnants. The reservoir can be easily observed due to the transparent wall material and can be pivoted open about pins 64 by a finger engagement against lip 66 for emptying purposes.

The handles 24 and 44 for the hole punch are preferably formed from contoured plastic materials and include soft overmolds 25 and 45 to provide a comfortable gripping action. Overmold 25 includes ribs 29 to facilitate squeezing the punch for manual operation thereof. The handles each have a pair of opposed stops 23 and 43 (FIG. 5) which engage to limit the pivot travel between the handles and the displacement of the punch 28.

It will be appreciated that the hole punch 10 functions in an efficient manner wherein the paper to be punched is slid into the mouth rearwardly and properly aligned by observing the punch 28 location through the transparent canopy 100. The handles 24 and 44 are then squeezed together to punch the hole from the paper at the desired location. The hole remnant is deposited in the reservoir 60.

The pivot assembly 50 comprises an internal pivot connection 54 which pivotally retains the lever arm 20 to the rest of the assembly. The pivot connection is spring loaded via spring 92 so that normally the handles are disposed in the illustrated relationship of FIG. 2. Squeezing of the handles forces the hammer 26 and punch 28 to move toward the anvil aperture 52 for punching a hole in the received paper. The engagement of the retaining ring 94 against the platform 88 underside limits the maximum (upward) pivoting of the hammer/punch.

What is claimed:

1. A hole punch comprising:
a first member comprising a first handle and a hammer having a punch;
a second member comprising a second handle pivotally mounting a said first member wherein said first handle opposes said second handle;
a first jaw defining an aperture and a second jaw, said first and second jaws disposed in fixed relationship to said second member and said first jaw opposes said second jaw and said punch aligns with said aperture; and
a reservoir in communication with said aperture and the interior of which is exteriorly visible, wherein said handles are normally biased apart and said punch is displaceable into said aperture upon forcing said first and second handles toward each other.

2. The hole punch of claim 1 wherein said first and second jaws have canopies which are formed of transparent or semi-transparent material.

3. The hole punch of claim 1 wherein portions of said first and second jaws form a mouth which converges inwardly and is spaced from said punch.

4. The hole punch of claim 1 wherein said first and second handles have a soft overmold portion.

5. The hole punch of claim 1 wherein said reservoir is defined by a canopy which can be pivotally moved between an open and a closed position.

6. The hole punch of claim 5 and further comprising a second canopy enclosing said hammer and at least a portion of said punch.

7. The hole punch of claim 5 wherein said canopy is formed of transparent or semi-transparent material.

8. The hole punch of claim 5 wherein said canopy further comprises a protruding tab.

9. The hole punch of claim 1 wherein said punch extends from a shaft which is encircled by a spring for biasing said punch away from said aperture.

10. The hole punch of claim 1 wherein said handles each further comprises a stop and the stops mutually which engage to limit the pivoting of the handles.
